(19) United States
(12) Patent Application Publication
(10) Pub. No.: US 2026/0286180 A1
(43) Pub. Date: Sep. 24, 2026

(54) ABRASIVE STICK AND POLISHING METHOD

(71) Applicants: TAIMEI CHEMICALS CO., LTD., Kamiina-gun, Nagano (JP); XEBEC TECHNOLOGY CO., LTD., Tokyo (JP)

(72) Inventors: Makikazu KARASAWA, Kamiina-gun, Nagano (JP); Shinnosuke YAMAZAKI, Kamiina-gun, Nagano (JP); Yuki MARUYAMA, Kamiina-gun, Nagano (JP)

(21) Appl. No.: 19/100,083

(22) PCT Filed: Feb. 9, 2023
(86) PCT No.: PCT/JP2023/004290

§ 371 Date: Nov. 10, 2025

(30) Foreign Application Priority Data
Aug. 2, 2022 (JP) 2022-123474
Dec. 27, 2022 (JP) 2022-209626

(51) Int. Cl. C09G 1/02; B24B 23/02; B24B 23/04; B24D 3/28

(52) U.S. Cl. CPC C09G 1/02; B24B 23/02; B24B 23/04; B24D 3/28

(57) ABSTRACT

An abrasive stick (10) polishes a surface (S) to be polished of a workpiece (W) with a distal end portion (17) pressed against the surface (S) to be polished. The abrasive stick (10) includes inorganic filaments (15) and a resin impregnating the inorganic filaments (15) and cured. The inorganic filaments (15) contain 80 to 90% by weight of an alumina component and 20 to 10% by weight of a silica component. The inorganic filaments (15) have a crystal structure including mullite crystals and intermediate alumina. The mullite crystals have an average grain size smaller than 25 nm.

### FIELD

The present invention relates to an abrasive stick. The present invention also relates to a polishing method using an abrasive stick.

### BACKGROUND

A rod-shaped abrasive stick formed by impregnating and curing a bundle of yarn aggregates of inorganic filaments with a resin is described in Patent Literature 1. The abrasive stick in this literature is used for polishing molds. The abrasive stick is rectangular or circular in cross section and has elasticity to flex in a direction intersecting its axis. The yarn aggregates of inorganic filaments extend in the axial direction of the abrasive stick, and the cross sections of the yarn aggregates are exposed on a distal end surface of the abrasive stick.

In Patent Literature 1, the proximal portion of the abrasive stick is held in a tool holder when polishing a surface to be polished of a workpiece. The tool holder is connected to the spindle of a machine tool, and the spindle is rotated to press the distal end surface of the abrasive stick against the surface to be polished of the workpiece. Here, the tool holder converts spindle rotation into linear reciprocating motion and rotational motion in the axial direction of the spindle. Thus, the distal end portion of the abrasive stick is intermittently pressed against the workpiece to polish the surface to be polished. The distal end portion of the abrasive stick also comes into contact with the workpiece while rotating to polish the surface to be polished.

An abrasive material used for grinding stone is described in Patent Literature 2. The abrasive material in this literature is made of inorganic filaments impregnated with a resin. The inorganic filaments contain 80 to 90% by weight of an alumina component and 20 to 10% by weight of a silica component. The crystal structure of the inorganic filaments includes mullite crystals and intermediate alumina. The mullite crystals have an average grain size of 25 nm to 70 nm. In the abrasive material in this literature, since the inorganic filaments contain 80% by weight or more of an alumina component, the hardness of the inorganic filaments is high. Since the mullite crystals have an average grain size of 25 nm or more, the grinding power to polish and grind a workpiece is large.

Patent Literature 2 describes a rectangular grinding stone made of the above abrasive material. When polishing a workpiece, the grinding stone is pressed at the entire side surface extending in the longitudinal direction against a surface to be polished of the workpiece. The grinding stone is reciprocated along the surface to be polished.

### CITATION LIST

### Patent Literature

Patent Literature 1: Japanese Patent No. 6832555
Patent Literature 2: Japanese Patent Application Laid-open Publication No. H10-183427

### SUMMARY

### Technical Problem

If the abrasive material for grinding stone described in Patent Literature 2 is formed into a rod shape to make an abrasive stick, the abrasive stick can have sufficient grinding power. However, with higher precision of molds in recent years, the abrasive stick made of the abrasive material for grinding stone described in Patent Literature 2 may fail to achieve a desired surface roughness through polishing. The inventors have made elaborate studies and found that the abrasive stick made of the abrasive material for grinding stone described in Patent Literature 2 has room for improvement in wear resistance of the abrasive stick.

In view of this, an object of the present invention is to provide an abrasive stick that can improve the surface roughness of a surface to be polished of a workpiece and improve wear resistance. Another object is to provide a polishing method using such an abrasive stick.

### Solution to Problem

The inventors of the present invention have conducted elaborate studies and have found that when an abrasive stick employs an abrasive material including inorganic filaments that contain 80 to 90% by weight of an alumina component and 20 to 10% by weight of a silica component and have a crystal structure including intermediate alumina and mullite, the larger the crystallites of the mullite crystals in the crystal structure, the more likely scratches (polishing flaws) occur on a surface to be polished of a workpiece.

As a result of elaborate studies, the inventors also have found that when an abrasive stick employs an abrasive material including inorganic filaments that contain 80 to 90% by weight of an alumina component and 20 to 10% by weight of a silica component and have a crystal structure including intermediate alumina and mullite, the larger the crystallites of the mullite crystals in the crystal structure, the more the wear resistance of the abrasive stick is affected. In other words, mullitization proceeds in the inorganic filaments having large crystallites. As the mullitization proceeds, the inorganic filaments become brittle. Here, when a surface to be polished of a workpiece is polished using a rod-shaped abrasive stick made of inorganic filaments, the distal end portion of the abrasive stick is pressed against the surface to be polished. Since the abrasive stick has elasticity to flex in a direction intersecting the axis, when the distal end portion is pressed against the workpiece, the abrasive stick is less likely to bounce or chatter on the surface to be polished and the abrasive stick is less likely to be damaged or broken. Thus, when pressed against a surface to be polished, the distal end portion of the abrasive stick is pressed with a relatively large pressing force in consideration of its elasticity to ensure desired grinding power. As a result, the distal end portion of the abrasive stick is often subjected to load, and if the inorganic filaments exposed on the distal end surface are mullitized, the inorganic filaments become brittle and collapse, and easily wear out.

On the other hand, the inventors have found that when an abrasive stick employs an abrasive material including inorganic filaments containing 80 to 90% by weight of an alumina component and 20 to 10% by weight of a silica component, the grinding power of the abrasive stick can be ensured even with mullite crystals smaller than 25 nm. In other words, if the inorganic filaments contain 80% by weight or more of an alumina component, the hardness of the abrasive stick can be ensured. If the mullite crystals are smaller than 25 nm, mullitization is suppressed in the inorganic filaments, and thus embrittlement of the inorganic filaments is suppressed. As a result, when the distal end portion of the abrasive stick is pressed against a workpiece to polish a surface to be polished, brittle collapse of the inorganic filaments is suppressed and the inorganic filaments bite into the workpiece. Furthermore, unlike a case where a workpiece is polished by bringing the entire side surface extending in the longitudinal direction into contact with a surface to be polished, as in a rectangular grinding stone, when a workpiece is ground and polished by the rod-shaped abrasive stick, the distal end portion can be pressed against the surface to be polished with a pressing force in consideration of the elasticity of the abrasive stick. Thus, the abrasive stick can have predetermined grinding power. The present invention is based on these findings.

In order to solve the above problem, the present invention provides an abrasive stick in a rod shape having a distal end portion pressed against a surface to be polished of a workpiece to polish the surface to be polished. The abrasive stick includes a plurality of inorganic filaments extending in an axial direction, and a resin impregnating the inorganic filaments and solidified. Cross sections of the inorganic filaments are exposed on a distal end surface of the abrasive stick. The abrasive stick has elasticity to flex in a direction intersecting the axial direction. The inorganic filaments contain 80 to 90% by weight of an alumina component and 20 to 10% by weight of a silica component. The inorganic filaments have a crystal structure including mullite crystals and intermediate alumina. The mullite crystals have an average grain size smaller than 25 nm. A peak of a diffraction line of a (110) plane of mullite appears in a diffraction chart obtained by irradiating the inorganic filaments with X-rays. The average grain size of the mullite crystals is calculated by the following formula based on the diffraction chart.

$$\\ \begin{matrix}{D}_{hkl} = \frac{0.9 λ}{{β}_{\frac{1}{2}} \cdot cos θ} & [ Math . 1 ]\end{matrix}$$

Dₕₖₗ: an average grain size of a (210) plane
   λ: a wavelength of X-rays
   θ: a glancing angle of X-rays
   β_{1/2}: a full width at half maximum of a diffraction line of the (210) plane of mullite in which a crystal structure 2θ by X-ray diffraction appears near 26°.

In the abrasive stick according to the present invention, the mullite crystals have an average grain size smaller than 25 nm in the crystal structure of the inorganic filaments. This structure can suppress the occurrence of scratches (polishing flaws) on a surface to be polished of a workpiece due to the size of mullite crystals. As a result, the surface roughness of the surface to be polished can be improved. In the abrasive stick according to the present invention, the mullite crystals have an average grain size smaller than 25 nm in the crystal structure of the inorganic filaments. This structure can suppress embrittlement of the inorganic filaments. Thus, brittle collapse of the inorganic filaments can be suppressed when the distal end portion of the abrasive stick with exposed cross sections of the inorganic filaments on the distal end surface is pressed against a surface to be polished of a workpiece to perform polishing. As a result, the wear resistance of the abrasive stick is improved.

On the other hand, since the inorganic filaments contain 80% by weight or more of an alumina component, the hardness is ensured. Further, smaller mullite crystals can suppress embrittlement of the inorganic filaments. Thus, when the distal end portion of the abrasive stick is pressed against a surface to be polished of a workpiece to perform polishing, brittle collapse of the inorganic filaments is suppressed and the inorganic filaments bite into the workpiece. Furthermore, unlike a case where the entire side surface extending in the longitudinal direction is brought into contact with a surface to be polished to polish a workpiece, as in a rectangular grinding stone, when a workpiece is ground and polished by the rod-shaped abrasive stick, the distal end portion can be pressed against the surface to be polished to perform polishing. Since the rod-shaped abrasive stick has elasticity to flex in a direction intersecting its axis, even when the distal end portion is pressed against a surface to be polished, the abrasive stick is less likely to bounce or chatter on the surface to be polished and the abrasive stick is less likely to be damaged or broken. Thus, desired grinding power can be obtained by pressing the distal end portion of the abrasive stick against the surface to be polished with a pressing force in consideration of the elasticity of the abrasive stick. Thus, the grinding power of the abrasive stick can be ensured even when the mullite crystals have an average grain size of 25 nm or less.

In the present invention, it is preferable that the mullite crystals have an average grain size of 20 nm or less. This configuration can easily improve the surface roughness of a surface to be polished. Further, the wear resistance of the abrasive stick can be further improved.

In the present invention, it is preferable that the inorganic filaments have 85% by weight or more of an alumina component. With this configuration, the hardness of the inorganic filaments is easily increased. Thus, the grinding power of the abrasive stick can be easily ensured.

In the present invention, the resin may be epoxy resin.

In the present invention, the abrasive stick may have a bending strength of 500 MPa or more and a bending elasticity of 50 GPa or more. With this configuration, desired grinding power is easily obtained by increasing the pressing force that presses the distal end portion of the abrasive stick against a surface to be polished.

A polishing method according to the present invention includes: attaching the abrasive stick described above to a vibratory tool; and vibrating a distal end portion of the abrasive stick in the axial direction while pressing the distal end portion against a surface to be polished of a workpiece. The polishing method performed while pressing the distal end portion of the abrasive stick against a surface to be polished of a workpiece includes a polishing method performed while pressing a distal end surface of the abrasive stick against a surface to be polished of a workpiece.

A polishing method according to the present invention includes: attaching the abrasive stick described above to a vibratory tool; and vibrating a distal end portion of the abrasive stick in the axial direction and in a direction intersecting an axis of the abrasive stick while pressing the distal end portion against a surface to be polished of a workpiece. The polishing method performed while pressing the distal end portion of the abrasive stick against a surface to be polished of a workpiece includes a polishing method performed while pressing a distal end surface of the abrasive stick against a surface to be polished of a workpiece.

Furthermore, a polishing method according to the present invention includes: attaching the abrasive stick described above to a rotary tool; and rotating a distal end portion of the abrasive stick pressed against a surface to be polished of a workpiece. The abrasive stick has a circular cross section. The polishing method performed while pressing the distal end portion of the abrasive stick against a surface to be polished of a workpiece includes a polishing method performed while pressing a distal end surface of the abrasive stick against a surface to be polished of a workpiece.

### BRIEF DESCRIPTION OF DRAWINGS

FIG. 1 is a perspective view of an abrasive stick.

FIG. 2 is an illustration of a method of polishing a workpiece using the abrasive stick in FIG. 1.

FIG. 3 is an illustration of another example of the method of polishing a workpiece using the abrasive stick in FIG. 1.

FIG. 4 is a perspective view of a cylindrical abrasive stick.

FIG. 5 is an illustration of a method of polishing a workpiece using the abrasive stick in FIG. 4.

FIG. 6 is an illustration of another example of the method of polishing a workpiece using the abrasive stick in FIG. 4.

FIG. 7 is a flowchart of a method of producing the abrasive stick.

FIG. 8 is a diffraction chart obtained by irradiating inorganic filaments in Example 1 with X-rays.

FIG. 9 is a diffraction chart obtained by irradiating inorganic filaments in Comparative Example 1 with X-rays.

FIG. 10 is a roughness curve of a surface to be polished of a workpiece polished by the abrasive stick of Example 1.

FIG. 11 is a roughness curve of a surface to be polished of a workpiece polished by an abrasive stick of Comparative Example 1.

FIG. 12 is a graph illustrating the amount of grinding of a workpiece after a comparative test.

FIG. 13 is a graph of the amount of wear of the abrasive stick after the comparative test.

FIG. 14 is a diffraction chart obtained by irradiating inorganic filaments in Example 2 with X-rays.

FIG. 15 is a diffraction chart obtained by irradiating inorganic filaments in Reference Example with X-rays.

FIG. 16 is a diffraction chart obtained by irradiating inorganic filaments in Comparative Example 2 with X-rays.

FIG. 17 is a roughness curve of a surface to be polished of a workpiece polished by the abrasive stick of Example 2.

FIG. 18 is a roughness curve of a surface to be polished of a workpiece polished by an abrasive stick of Reference Example.

FIG. 19 is a roughness curve of a surface to be polished of a workpiece polished by an abrasive stick of Comparative Example 2.

FIG. 20 is a graph illustrating the amount of grinding of a workpiece after a comparative test.

FIG. 21 is a graph of the amount of wear of the abrasive stick after the comparative test.

### DESCRIPTION OF EMBODIMENTS

An abrasive stick according to embodiments of the present invention will be described below with reference to the drawings.

### Abrasive Stick

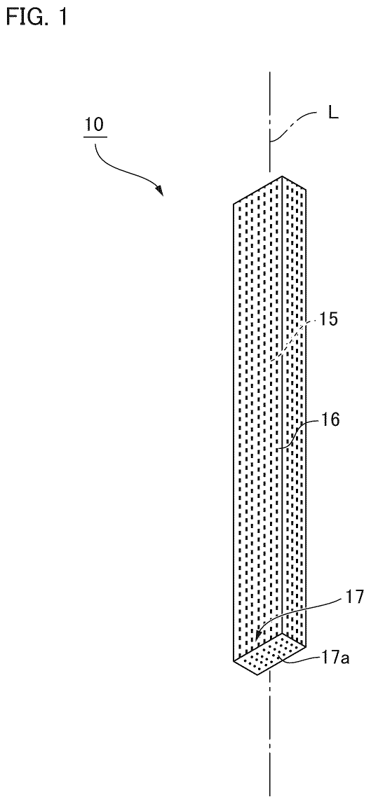

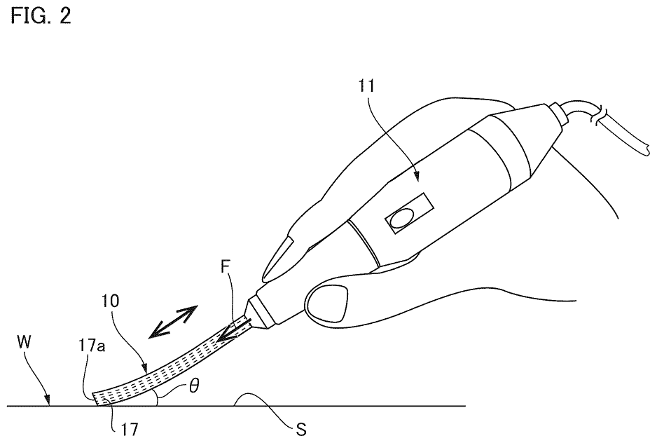

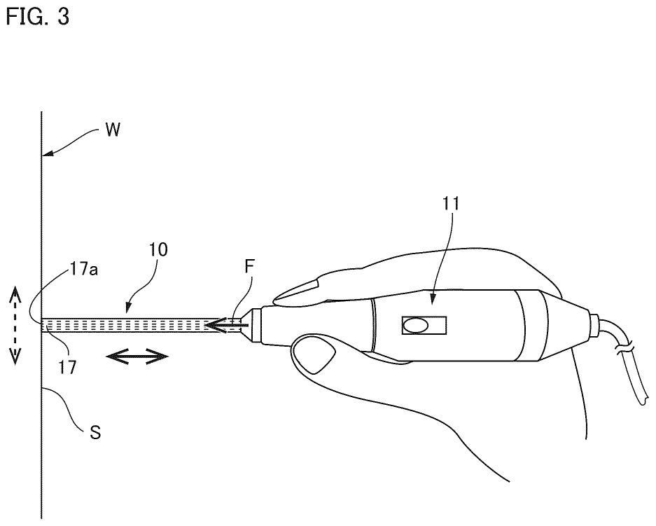

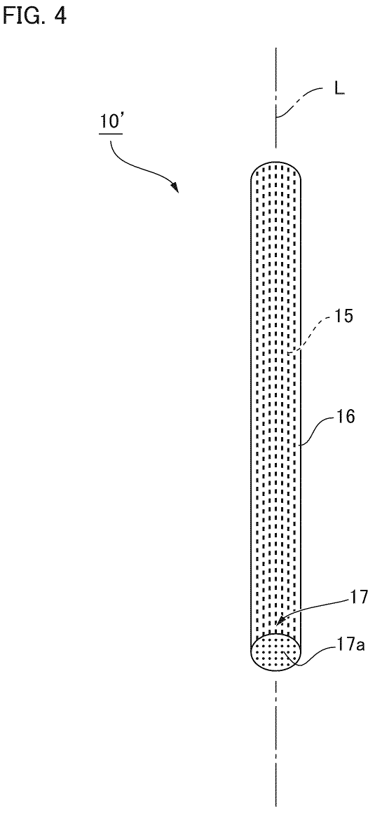

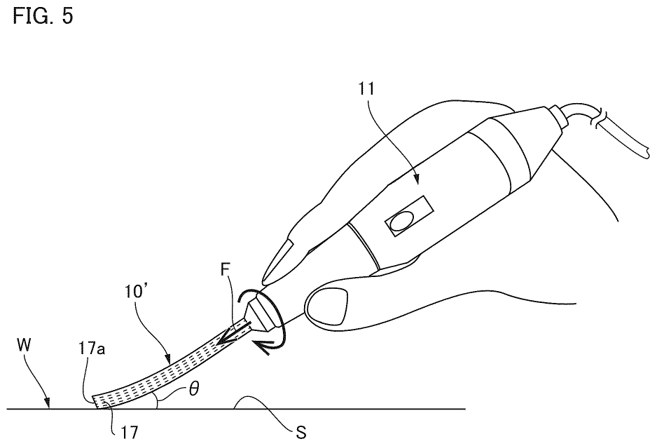

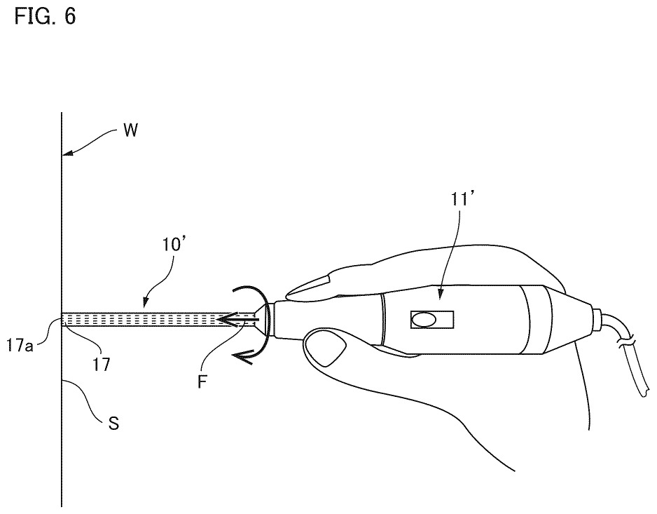

FIG. 1 is a perspective view of an abrasive stick. FIG. 2 is an illustration of a method of polishing a workpiece using the abrasive stick in FIG. 1. FIG. 3 is an illustration of another example of the method of polishing a workpiece using the abrasive stick in FIG. 1. FIG. 4 is a perspective view of a cylindrical abrasive stick. FIG. 5 is an illustration of a method of polishing a workpiece using the abrasive stick in FIG. 4. FIG. 6 is an illustration of another example of the method of polishing a workpiece using the abrasive stick in FIG. 4.

As illustrated in FIG. 1, an abrasive stick 10 is rod-shaped and is rectangular in cross section. In this example, the abrasive stick 10 has a rectangular cross section. The abrasive stick 10 includes a plurality of inorganic filaments 15 extending in the axial direction along its axis L and a resin 16 that impregnates the inorganic filaments 15 and solidifies. The inorganic filaments 15 are polycrystalline fibers and contain 80 to 90% by weight of an alumina component and 20 to 10% by weight of a silica component. Cross sections of the inorganic filaments 15 are exposed on a distal end surface 17a of the abrasive stick 10.

The abrasive stick 10 has elasticity to flex in a direction intersecting its axis L. The abrasive stick 10 has a bending strength of 500 MPa or more. The abrasive stick 10 has a bending elasticity of 50 GPa or more. More preferably, the abrasive stick 10 has a bending strength of 800 MPa or more, and the abrasive stick 10 has a bending elasticity of 65 GPa or more. Although the inorganic filaments 15 are depicted by chain lines for convenience in FIG. 1 and the like, the inorganic filaments 15 extend continuously from the distal end to the proximal end side of the abrasive stick 10. A plurality of inorganic filaments 15 may be inclined with respect to the axis L of the abrasive stick 10. In this case, however, the angle of inclination is about 10° and does not exceed 20° at most.

### Polishing Method

As illustrated in FIG. 2, the abrasive stick 10 is used with its proximal end portion attached to the head of a hand-held vibratory tool. The vibratory tool is, for example, a pneumatic vibratory tool or an ultrasonic vibratory tool. The vibratory tool reciprocates (vibrates) the abrasive stick 10 mounted on the head in the axial direction. A workpiece W to be polished by the abrasive stick 10 is, for example, a mold for resin molding.

When polishing the workpiece W, the abrasive stick 10 is pressed at its distal end portion 17 obliquely against a surface S to be polished of the workpiece W. In other words, the abrasive stick 10 is pressed against the surface S to be polished in a posture in which the angle θ between its axis L and the surface S to be polished is an acute angle. In this example, one of long sides of the rectangular cross section of the abrasive stick 10 faces the surface S to be polished. When polishing the workpiece W, the abrasive stick 10 is pressed against the surface S to be polished of the workpiece W from a direction along the axis L with a predetermined pressing force F. Furthermore, as indicated by the arrow in FIG. 2, when polishing the workpiece W, the abrasive stick 10 is vibrated in the axial direction. In a case where the vibratory tool 11 is a pneumatic vibratory tool, the pneumatic vibratory tool vibrates the abrasive stick 10 at 5000 st/min or more. In a case where the vibratory tool 11 is an ultrasonic vibratory tool, the ultrasonic vibratory tool vibrates the abrasive stick 10 at 15 kHz or higher.

As illustrated in FIG. 3, the abrasive stick 10 may be pressed at its distal end surface 17a vertically against the surface S to be polished of the workpiece W to polish the workpiece W. Also in this case, the abrasive stick 10 is pressed against the surface S to be polished with a pressing force F from the direction along the axis L. As indicated by the solid arrow in FIG. 3, the abrasive stick 10 is vibrated in the axial direction by the vibratory tool 11. In a case where the vibratory tool 11 is a pneumatic vibratory tool, the pneumatic vibratory tool vibrates the abrasive stick 10 at 5000 st/min or more. In a case where the vibratory tool 11 is an ultrasonic vibratory tool, the ultrasonic vibratory tool vibrates the abrasive stick 10 at 15 kHz or higher.

Here, as indicated by the solid arrow and the chain arrow in FIG. 3, in a case where a pneumatic vibratory tool is used, the abrasive stick 10 may be vibrated by the pneumatic vibratory tool in the axial direction and in the direction orthogonal to the axis L. In this case, the pneumatic vibratory tool swings the abrasive stick 10 along an elliptical orbit during a stroke that vibrates the abrasive stick 10 in the axial direction to achieve vibration in the axial direction and in the direction orthogonal to the axis L. In this case, the pneumatic vibratory tool vibrates the abrasive stick 10 at 5000 st/min or more.

In a case where a pneumatic vibratory tool is used, as illustrated in FIG. 2, the abrasive stick 10 may also be vibrated in the axial direction and in the direction orthogonal to the axis L when the distal end portion 17 of the abrasive stick 10 is pressed obliquely against the surface S to be polished to polish the workpiece W.

As illustrated in FIG. 5, the abrasive stick 10 may be used with its proximal end portion attached to the head of a hand-held rotary tool 11′. In this case, as illustrated in FIG. 4, the abrasive stick attached to the rotary tool 11′ is preferably an abrasive stick 10′ with a circular cross section. In other words, it is preferable that the abrasive stick 10′ having a cylindrical shape is attached to the rotary tool 11′. The rotary tool 11′ is, for example, an electric rotary tool or a pneumatic rotary tool. As indicated by the solid arrows in FIG. 5, the rotary tool 11′ rotates the abrasive stick 10′ around its axis.

As illustrated in FIG. 5, when polishing the workpiece W, the abrasive stick 10′ is pressed at its distal end portion 17 obliquely against the surface S to be polished of the workpiece W. In other words, the abrasive stick 10′ is pressed against the surface S to be polished in a posture in which the angle θ between its axis L and the surface S to be polished is an acute angle. When polishing the workpiece W, the abrasive stick 10′ is pressed against the surface S to be polished of the workpiece W from a direction along the axis L with a predetermined pressing force F. Furthermore, the abrasive stick 10′ is rotated around the axis with the distal end portion 17 pressed against the surface S to be polished. The rotary tool 11′ rotates the abrasive stick 10 at 100 revolutions/min or more.

Here, even when the abrasive stick 10′ is attached to the rotary tool 11′ to perform polishing, as illustrated in FIG. 6, the distal end surface 17a of the abrasive stick 10′ may be pressed vertically against the surface S to be polished of the workpiece W and rotated. Also in this case, the abrasive stick 10′ is pressed against the surface S to be polished with a pressing force F from a direction along the axis L. The rotary tool 11′ rotates the abrasive stick 10 at 100 revolutions/min or more.

In any of the above polishing methods, when the abrasive stick 10 is used to polish the surface S to be polished of the workpiece, the abrasive stick 10 may flex in a direction intersecting its axis L due to the pressing force F that presses the abrasive stick 10 against the surface S to be polished or the reaction force from the surface S to be polished.

The abrasive sticks 10 and 10′ can also be used without being attached to a vibratory tool or the like. In this case, an operator presses the distal end portion 17 of the abrasive stick 10, 10′ against the surface S to be polished of the workpiece W to perform manual polishing.

### Method of Producing Abrasive Stick

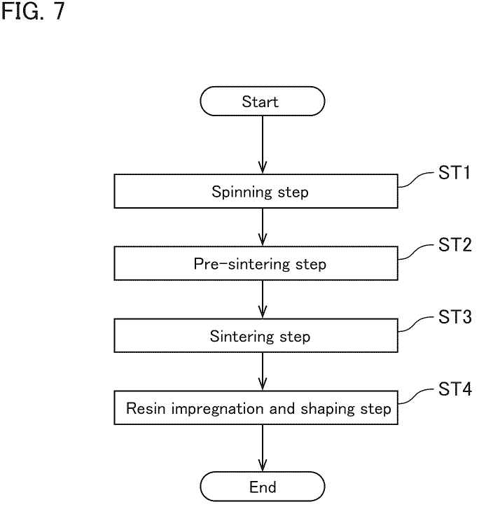

FIG. 7 is a flowchart of a method of producing the abrasive stick 10. As illustrated in FIG. 7, a method of producing the abrasive stick 10 includes a spinning step ST1, a pre-sintering step ST2, a sintering step ST3, and a resin impregnation and shaping step ST4 in this order. In the spinning step ST1, an aqueous spinning solution containing basic aluminum chloride, colloidal silica, and polyvinyl alcohol is dry-spun to obtain precursor fibers. In the pre-sintering step ST2, the precursor fibers are fired at 900° C. or higher and 1300° C. or lower into ceramic to obtain inorganic filaments. In the sintering step ST3, the inorganic filaments are heated at high temperatures of 1300° C. or higher for around 20 seconds. The heating temperature in the sintering step ST3 is higher than the heating temperature in the pre-sintering step ST2.

In the resin impregnation and shaping step ST4, the inorganic filaments are aligned as appropriate to form yarn aggregates. In the resin impregnation and shaping step ST4, the yarn aggregates are impregnated with a thermosetting resin such as epoxy resin or phenolic resin. Furthermore, in the resin impregnation and shaping step ST4, the resin-impregnated yarn aggregates are aligned to make a bundle of yarn aggregates. Furthermore, in the resin impregnation and shaping step ST4, the bundle of resin-impregnated yarn aggregates is drawn to pass through a die having an opening with a predetermined shape, and then cured via a heating furnace. The bundle of resin-cured yarn aggregates is then cut into a predetermined length. In this way, the abrasive stick 10 having a predetermined length dimension and a predetermined cross-sectional shape is obtained.

A specific example of the production method will be described below. First, in the spinning step ST1, 34 kg of an aqueous solution of basic aluminum chloride containing 13.2% by weight of aluminum ions and 11.45% by weight of chlorine ions, 7.5 kg of colloidal silica containing 20% by weight of silicon dioxide, and 2.5 kg of partially saponified polyvinyl alcohol with an average degree of polymerization of 1700 are dissolved to prepare a spinning solution with a viscosity of approximately 1000 poise/20° C. Next, the spinning solution is extruded through a 1000-hole spinning nozzle for dry spinning. In the pre-sintering step ST2, the spun inorganic filaments are fired at 900° C. to 1300° C. into ceramic to obtain yarn aggregates. Then, in the sintering step ST3, the yarn aggregates are passed through a pipe furnace at 1300° C. to 1400° C. and continuously wound onto a first bobbin under tension. Here, the passing speed of the yarn aggregates is adjusted so that the heating time is 20 seconds. Here, the yarn aggregates are wound onto a plurality of first bobbins.

In the resin impregnation and shaping step ST4, the yarn aggregate is unrolled from each of the first bobbins and passed through a resin tank in which uncured resin is stored. The resin-impregnated yarn aggregates passed through the resin tank are aligned to make a bundle, which is in turn passed through a heating furnace.

The resin to impregnate the yarn aggregates and the bundle of yarn aggregates can have the following composition.
Epoxy resin (jER828 manufactured by Mitsubishi Chemical Corporation) 100 parts by weight
Tetrahydromethylphthalic anhydride (HN-2200 manufactured by Hitachi Chemical Company, Ltd.) 85 parts by weight
Imidazole (2E4MZ-CN manufactured by SHIKOKU KASEI HOLDINGS CORPORATION) 2 parts by weight

Here, in the resin impregnation and shaping step ST4, the bundle of resin-impregnated yarn aggregates is passed through a die having an opening with a predetermined shape before reaching the heating furnace. As a result, the bundle of resin-impregnated yarn aggregates has a cross-sectional shape corresponding to the opening shape of the die. In the resin impregnation and shaping step ST4, the impregnating resin is cured via the heating furnace. Thus, the bundle of resin-cured yarn aggregates is cut into a predetermined dimension. As a result, in a case where the die has a rectangular opening, an abrasive stick having a rectangular cross section and with a predetermined length dimension can be obtained. In a case where the die has a circular opening, an abrasive stick having a circular cross section and with a predetermined length dimension can be obtained.

### Example 1

The abrasive stick 10 of Example 1 is rod-shaped and is rectangular in cross section orthogonal to the axis L. The abrasive stick 10 has a thickness dimension (shorter dimension of the cross section) of 1 mm, a width dimension (longer dimension of the cross section) of 4 mm, and a length dimension of 100 mm. The abrasive stick 10 has a bending strength of 1200 MPa and a bending elasticity of 115 GPa.

The abrasive stick 10 includes a plurality of inorganic filaments 15 extending in the axial direction and a resin 16 that impregnates the inorganic filaments 15. The inorganic filaments 15 contain 85% by weight of an alumina component and 15% by weight of a silica component. The crystal structure of the inorganic filaments 15 includes mullite crystals and intermediate alumina. The crystal grains of the mullite crystals have an average grain size of 20 nm. The cross sections of the inorganic filaments 15 are exposed on the distal end surface 17a of the abrasive stick 10.

In production of the abrasive stick 10 of Example 1, the heating temperature in the pre-sintering step ST2 is 1000° C. The heating temperature in the sintering step ST3 is 1380° C. The heating time in the sintering step ST3 is 20 seconds.

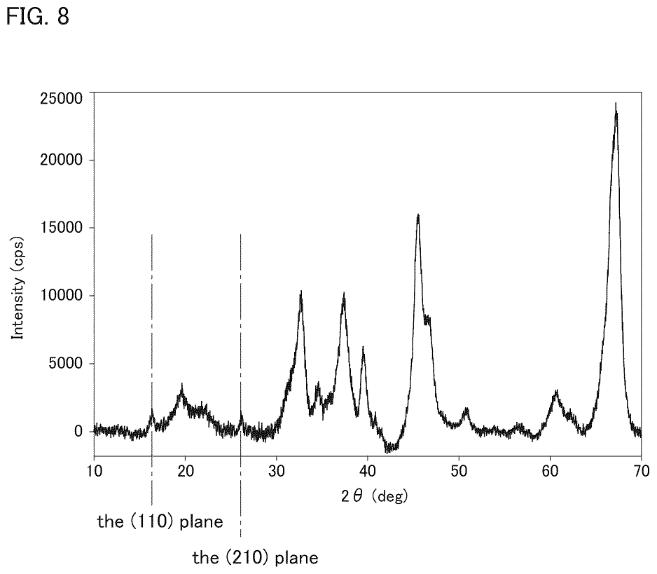

Here, the crystal structure of the inorganic filaments 15 was evaluated using X-ray diffraction. In other words, a diffraction chart was obtained by irradiating the inorganic filaments 15 with X-rays after the sintering step ST3 and before the resin impregnation and shaping step ST4. FIG. 8 is a diffraction chart obtained by irradiating the inorganic filaments 15 in Example 1 with X-rays. The average grain size of the mullite crystals was calculated using the following general formula, based on the diffraction chart.

$$\\ \begin{matrix}{D}_{hkl} = \frac{0.9 λ}{{β}_{\frac{1}{2}} \cdot cos θ} & [ Math . 1 ]\end{matrix}$$

Dₕₖₗ: the average grain size of the (210) plane
   λ: the wavelength of X-rays
   θ: the glancing angle of X-rays
   β_{1/2}: the full width at half maximum of the diffraction line of the (210) plane of mullite in which the crystal structure 2θ by X-ray diffraction appears near 26°.

The average grain size of the mullite crystals of the inorganic filaments 15 for which the diffraction chart in FIG. 8 was obtained is Dₕₖₗ=20 (nm).

The diffraction line of the (210) plane of mullite has a lower peak as the grain size of the mullite crystals decreases, and may be buried in other diffraction lines. For example, if the grain size of the mullite crystals is smaller than 25 nm, the peak of the diffraction line of the (210) plane of mullite may be buried in other diffraction lines, so that the full width at half maximum of the diffraction line may be unable to be obtained. The inventors therefore experimentally confirmed that the average grain size of the mullite crystals is 20 nm or less by using other measurement methods when the peak of the diffraction line of the (210) plane of mullite is buried in other diffraction lines and the full width at half maximum of the diffraction line is unable to be obtained. Even when the peak of the diffraction line of the (210) plane of mullite is buried in other diffraction lines, if the peak of the diffraction line of the (110) plane of mullite appears in the diffraction chart, it can be determined that the crystal structure of the inorganic filaments 15 has mullite crystals.

### COMPARATIVE EXAMPLE

An abrasive stick of Comparative Example 1 is rod-shaped and is rectangular in cross section orthogonal to the axis. The abrasive stick 10 has a thickness dimension (shorter dimension of the cross section) of 1 mm, a width dimension (longer dimension of the cross section) of 4 mm, and a length dimension of 100 mm. The abrasive stick has a bending strength of 1200 MPa and a bending elasticity of 120 GPa. The abrasive stick of Comparative Example 1 includes a plurality of inorganic filaments extending in the axial direction and a resin that impregnates the inorganic filaments. The inorganic filaments contain 85% by weight of an alumina component and 15% by weight of a silica component. The crystal structure of the inorganic filaments includes mullite crystals and intermediate alumina. The cross sections of the inorganic filaments are exposed on the distal end surface of the abrasive stick of Comparative Example 1.

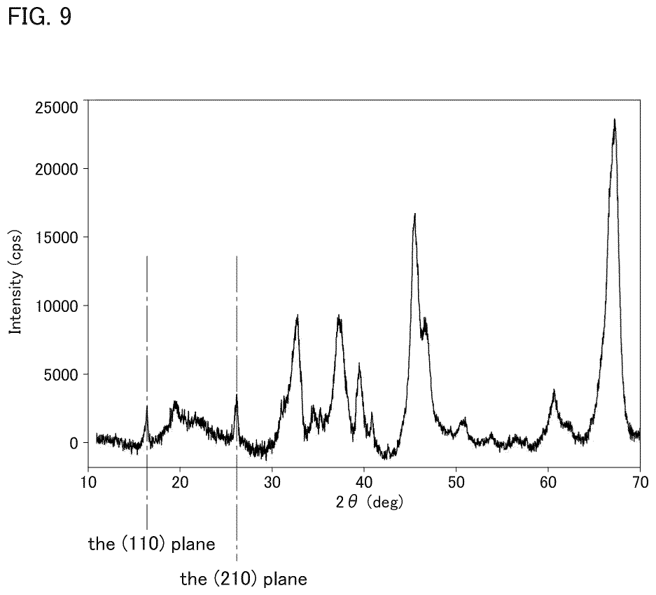

FIG. 9 is a diffraction chart obtained by irradiating the inorganic filaments in Comparative Example 1 with X-rays. The peak of the diffraction line of the (210) plane of mullite clearly appears in the diffraction chart in FIG. 9. The average grain size of the mullite crystals of the inorganic filaments in Comparative Example 1 that is obtained based on the diffraction chart in FIG. 9 is Dₕₖₗ=35 (nm). In other words, the crystal grains of the mullite crystals have an average grain size of 25 nm or more.

In production of the abrasive stick of Comparative Example 1, the heating temperature in the pre-sintering step ST2 is 1000° C. The heating temperature in the sintering step ST3 is 1390° C. The heating time in the sintering step ST3 is 30 seconds.

The heating temperature in the sintering step ST3 in Comparative Example 1 is higher than the heating temperature in the sintering step ST3 in Example 1. The heating time in the sintering step ST3 in Comparative Example 1 is longer than the heating time in the sintering step ST3 in Example 1. As a result, the abrasive stick of Comparative Example 1 includes mullite crystals with an average grain size of 25 nm or more in the crystal structure. Thus, the average grain size of mullite crystals in the crystal structure of the inorganic filaments can be controlled by controlling the heating temperature and the heating time in the sintering step ST3 in production of the abrasive stick.

### Comparative Test

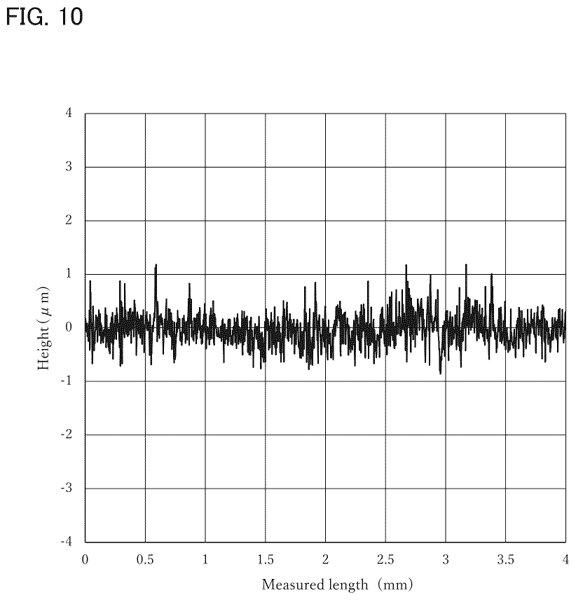

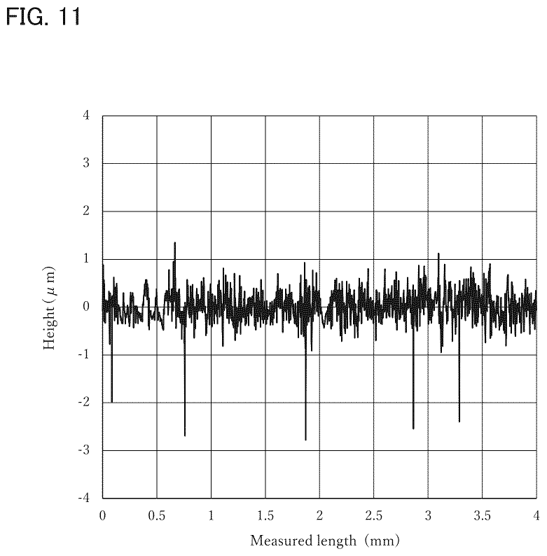

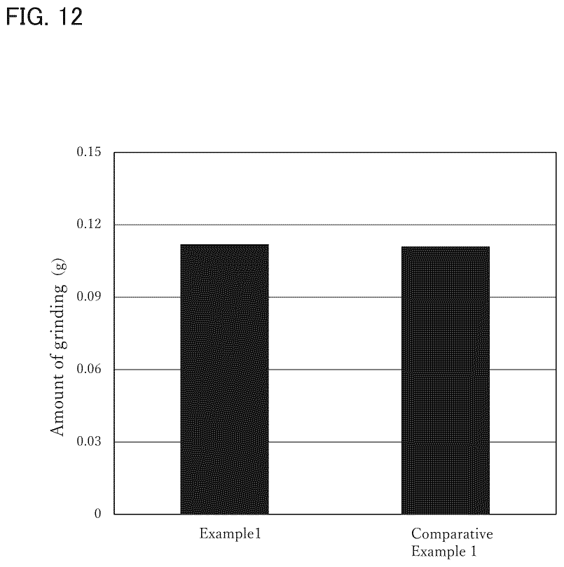

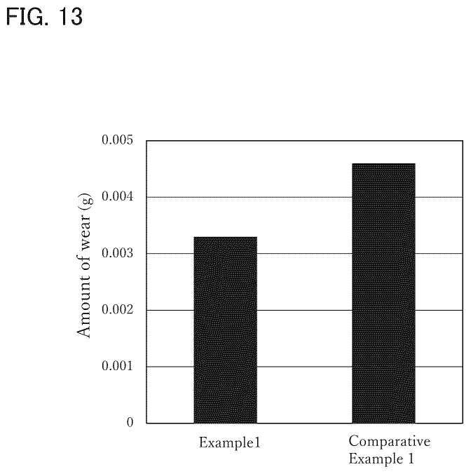

A comparative test was conducted in which a workpiece W was polished using the abrasive stick 10 of Example 1 and the abrasive stick of Comparative Example 1. FIG. 10 is a roughness curve of a surface to be polished of a workpiece polished using the abrasive stick of Example 1. FIG. 11 is a roughness curve of a surface to be polished of a workpiece polished using the abrasive stick of Comparative Example 1. FIG. 12 is a graph illustrating the amount of grinding of the workpiece after the comparative test in which the workpiece was polished using the abrasive sticks of Example 1 and Comparative Example 1. FIG. 13 is a graph of the amount of wear of each abrasive stick after the comparative test in which the workpiece was polished using the abrasive sticks of Example 1 and Comparative Example 1.

In the comparative test, the proximal end portion of the abrasive stick 10 was attached to the head of the hand-held vibratory tool 11 to polish the surface S to be polished of the workpiece W. The vibratory tool is a pneumatic vibratory tool. The workpiece W to be polished is a mold. The workpiece W is made of S50C (carbon steel for machine structural use).

More specifically, as illustrated in FIG. 2, when polishing the workpiece W, the abrasive stick 10 of Example 1 and the abrasive stick of Comparative Example 1 were set in a posture in which the angle θ between the axis L and the surface S to be polished was 30°. The distal end portion 17 of the abrasive stick 10 of Example 1 and the distal end portion of the abrasive stick of Comparative Example 1 were pressed against the surface S to be polished with a pressing force F of 6 N. Furthermore, the abrasive stick 10 of Example 1 and the abrasive stick of Comparative Example 1 were each vibrated by the vibratory tool 11 at 21000 st/min in the axial direction. Dry polishing for the workpiece W was then performed continuously for 3 minutes on a polishing area of 30 mm×30 mm.

As can be understood from the graph of the amount of grinding of the workpiece after the comparative test illustrated in FIG. 12, the abrasive stick 10 of Example 1 is found to have grinding power equivalent to the abrasive stick of Comparative Example 1.

The occurrence of scratches in the roughness curve of the surface to be polished of the workpiece polished with the abrasive stick 10 of Example 1 illustrated in FIG. 10 is less than the occurrence of scratches in the roughness curve of the surface to be polished of the workpiece polished using the abrasive stick of Comparative Example 1 illustrated in FIG. 11. Furthermore, the surface roughness of the surface S to be polished of the workpiece W polished with the abrasive stick 10 of Example 1 is Rz 2.0 μm. The surface roughness of the surface S to be polished of the workpiece W after polishing with the abrasive stick of Comparative Example 1 is Rz 4.1 μm. Thus, the polishing using the abrasive stick 10 of Example 1 can improve the surface roughness of the surface S to be polished of the workpiece W.

Furthermore, the graph of the amount of wear of the abrasive sticks after the comparative test illustrated in FIG. 13 indicates that the amount of wear of the abrasive stick 10 of Example 1 is smaller than the amount of wear of the abrasive stick of Comparative Example 1. Thus, the wear resistance of the abrasive stick 10 of Example 1 is improved compared with the abrasive stick of Comparative Example 1.

### Operation Effects

In the abrasive stick 10 of this example, the mullite crystals have an average grain size smaller than 25 nm in the crystal structure of the inorganic filaments 15. This structure can suppress the occurrence of scratches (polishing flaws) on a surface to be polished of a workpiece due to the size of the mullite crystals. As a result, the surface roughness of the surface to be polished can be improved.

In the abrasive stick 10 of this example, the mullite crystals have an average grain size smaller than 25 nm in the crystal structure of the inorganic filaments 15. This structure can suppress embrittlement of the inorganic filaments 15. Thus, brittle collapse of the inorganic filaments 15 can be suppressed when the distal end portion 17 of the abrasive stick 10 is pressed against the surface S to be polished of the workpiece W to perform polishing. Thus, the wear resistance of the abrasive stick 10 is improved.

On the other hand, since the inorganic filaments 15 contain 80% by weight or more of an alumina component, the hardness is ensured. Further, smaller mullite crystals can suppress embrittlement of the inorganic filaments 15. Thus, when the distal end portion 17 of the abrasive stick 10 is pressed against the surface S to be polished of the workpiece W to perform polishing, brittle collapse of the inorganic filaments 15 is suppressed and the inorganic filaments 15 into the workpiece W. In addition to this, unlike a rectangular grinding stone that performs polishing with the entire side surface in contact with the surface to be polished of the workpiece W, the abrasive stick 10 performs polishing with the distal end portion 17 pressed against the surface to be polished of the workpiece W. Since the abrasive stick 10 has elasticity to flex in a direction intersecting its axis L, the distal end portion 17 of the abrasive stick 10 can be pressed against the surface to be polished with a pressing force F in consideration of the elasticity of the abrasive stick 10. As a result, the grinding power of the abrasive stick 10 of Example 1 can be ensured even when the mullite crystals have an average grain size smaller than 25 nm.

Here, the experiment by the inventors has proven that the smaller the average grain size of mullite crystals in the crystal structure of the inorganic filaments 15, the higher the wear resistance of the abrasive stick 10.

When the inorganic filaments 15 contain 85% by weight or more of an alumina component, the hardness of the inorganic filaments 15 can be increased compared with when the alumina component content is lower than 85% by weight. Thus, in order to ensure the polishing power of the abrasive stick 10, it is desirable that 85% by weight or more of an alumina component is contained. When the alumina component content is 85% by weight or more, the silica component content is 15% by weight or less.

The inorganic filaments 15 may contain other components in addition to the alumina component and the silica component. Even in this case, the grinding power of the abrasive stick 10 can be ensured if the inorganic filaments 15 contain 80 to 90% by weight of an alumina component and 20 to 10% by weight of a silica component.

### Example 2, Reference Example, Comparative Example 2

Abrasive sticks 10 of Example 2, Reference Example, and Comparative Example 2 will now be described. The abrasive sticks 10 of Example 2, Reference Example, and Comparative Example 2 each include a plurality of inorganic filaments 15 extending in the axial direction and a resin 16 that impregnates the inorganic filaments 15, in the same manner as the abrasive stick 10 of Example 1. The inorganic filaments 15 contain 85% by weight of an alumina component and 15% by weight of a silica component. The crystal structure of the inorganic filaments 15 includes mullite crystals and intermediate alumina. The cross sections of the inorganic filaments 15 are exposed on the distal end surface 17a of each of the abrasive sticks 10 of Example 2 and Reference Example.

The abrasive sticks 10 of Example 2, Reference Example, and Comparative Example 2 each have the same shape as the abrasive stick 10 of Example 1. In other words, the abrasive sticks 10 of Example 2, Reference Example, and Comparative Example 2 are each rod-shaped and rectangular in cross section orthogonal to the axis L. The abrasive sticks 10 each have a thickness dimension of 1 mm, a width dimension of 4 mm, and a length dimension of 100 mm.

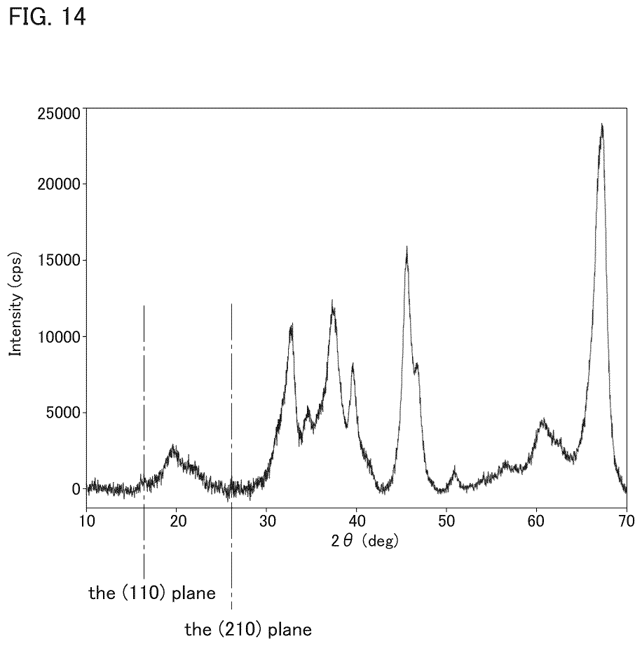

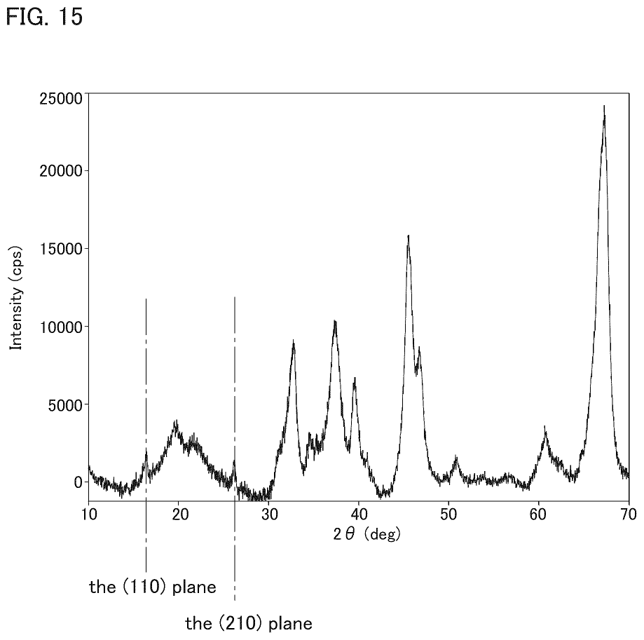

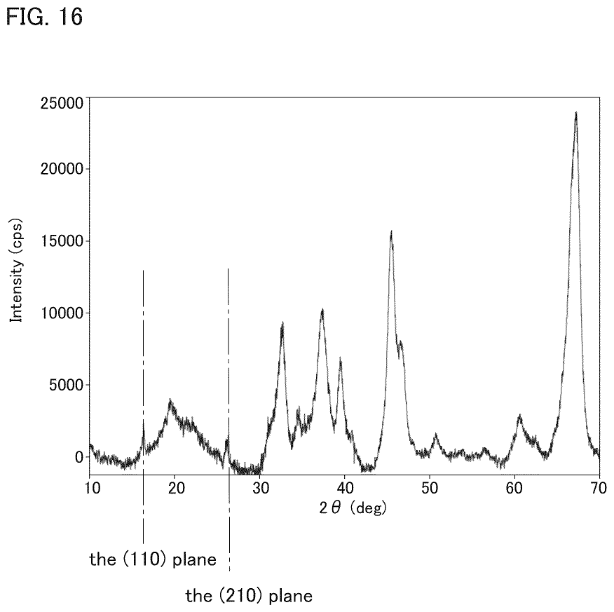

In Example 2, Reference Example, and Comparative Example 2, the crystal structure of the inorganic filaments 15 was evaluated using X-ray diffraction, in the same manner as in Example 1. In other words, a diffraction chart was obtained by irradiating the inorganic filaments 15 with X-rays after the sintering step ST3 and before the resin impregnation and shaping step ST4. FIG. 14 is a diffraction chart obtained by irradiating the inorganic filaments 15 in Example 2 with X-rays. FIG. 15 is a diffraction chart obtained by irradiating the inorganic filaments 15 in Reference Example with X-rays. FIG. 16 is a diffraction chart obtained by irradiating the inorganic filaments 15 in Comparative Example 2 with X-rays. The average grain size of the mullite crystals was calculated based on the diffraction chart using the general formula, in the same manner as in Example 1.

The average grain size of the mullite crystals of the inorganic filaments 15 obtained from the diffraction chart in Example 2 in FIG. 14 is Dₕₖₗ=10 (nm). In other words, the crystal grains of the mullite crystals of the inorganic filaments 15 in Example 2 have an average grain size of 10 nm. Here, the abrasive stick 10 of Example 2 has a bending strength of 1200 MPa and a bending elasticity of 112 GPa. In production of the abrasive stick 10 of Example 2, the heating temperature in the pre-sintering step ST2 is 1000° C. The heating temperature in the sintering step ST3 is 1370° C. The heating time in the sintering step ST3 is 20 seconds.

The average grain size of the mullite crystals of the inorganic filaments 15 obtained from the diffraction chart in Reference Example in FIG. 15 is Dₕₖₗ=25 (nm). In other words, the crystal grains of the mullite crystals of the inorganic filaments 15 in Reference Example have an average grain size of 25 nm. Here, the abrasive stick 10 of Reference Example has a bending strength of 1200 MPa and a bending elasticity of 116 GPa. In production of the abrasive stick 10 of Reference Example, the heating temperature in the pre-sintering step ST2 is 1000° C. The heating temperature in the sintering step ST3 is 1385° C. The heating time in the sintering step ST3 is 20 seconds.

The average grain size of the mullite crystals of the inorganic filaments 15 obtained from the diffraction chart in Comparative Example 2 in FIG. 16 is Dₕₖₗ=30 (nm). In other words, the crystal grains of the mullite crystals of the inorganic filaments 15 in Comparative Example 2 have an average grain size of 30 nm. Here, the abrasive stick 10 of Comparative Example 2 has a bending strength of 1200 MPa and a bending elasticity of 117 GPa. In production of the abrasive stick 10 of Comparative Example 2, the heating temperature in the pre-sintering step ST2 is 1000° C. The heating temperature in the sintering step ST3 is 1390° C. The heating time in the sintering step ST3 is 20 seconds.

### Comparative Test

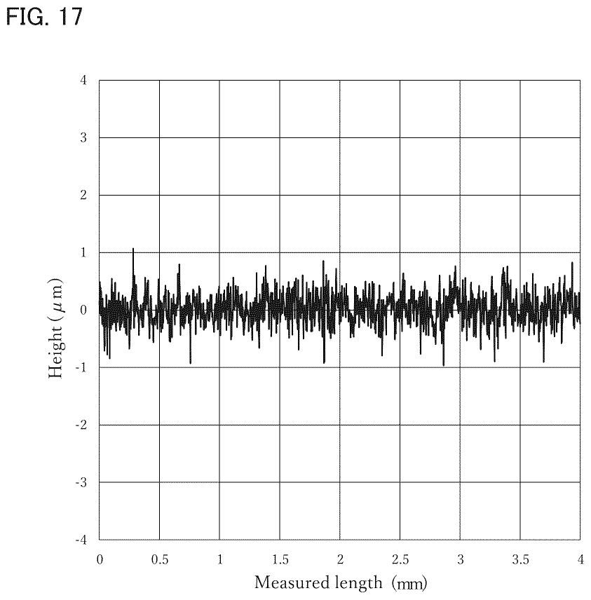

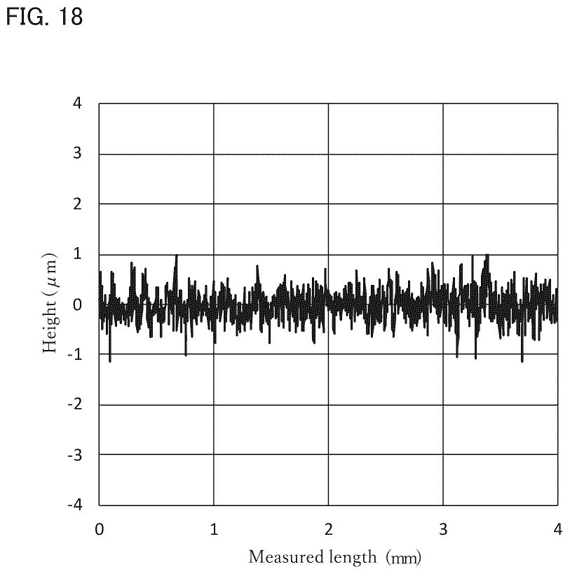

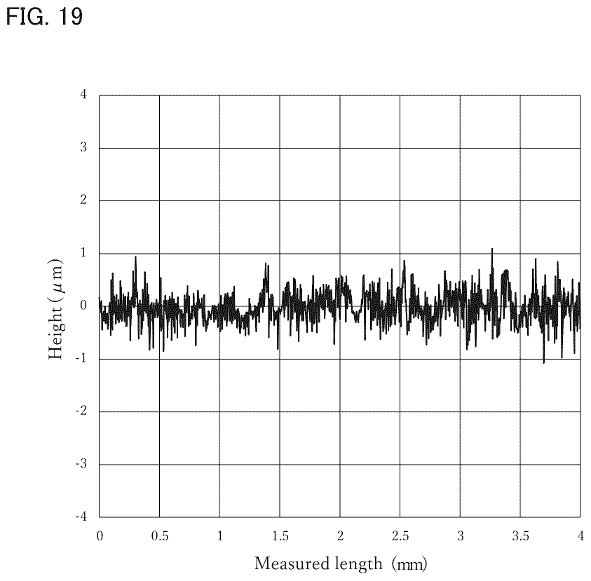

A comparative test similar to the comparative test described above was conducted using the abrasive stick 10 of Example 2, the abrasive stick 10 of Reference Example, and the abrasive stick 10 of Comparative Example 2. FIG. 17 is a roughness curve of a surface to be polished of a workpiece polished using the abrasive stick 10 of Example 2. FIG. 18 is a roughness curve of a surface to be polished of a workpiece polished using the abrasive stick 10 of Reference Example. FIG. 19 is a roughness curve of a surface to be polished of a workpiece polished using the abrasive stick 10 of Comparative Example 2. In FIGS. 17, 18, and 19, the horizontal axis represents the measured length (mm) and the vertical axis represents the height (μm).

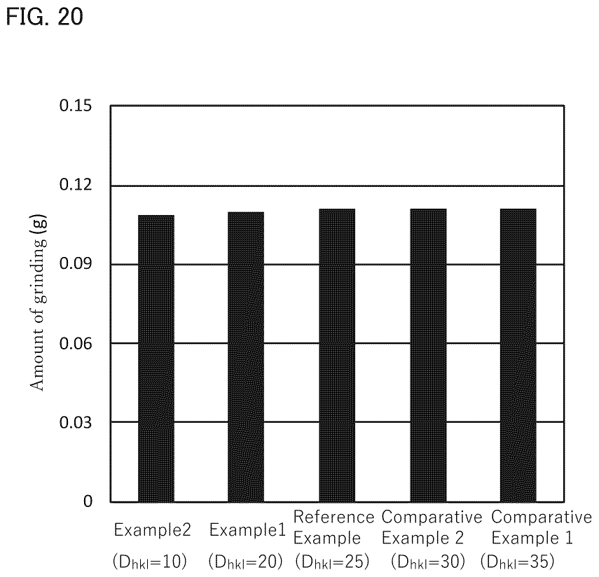

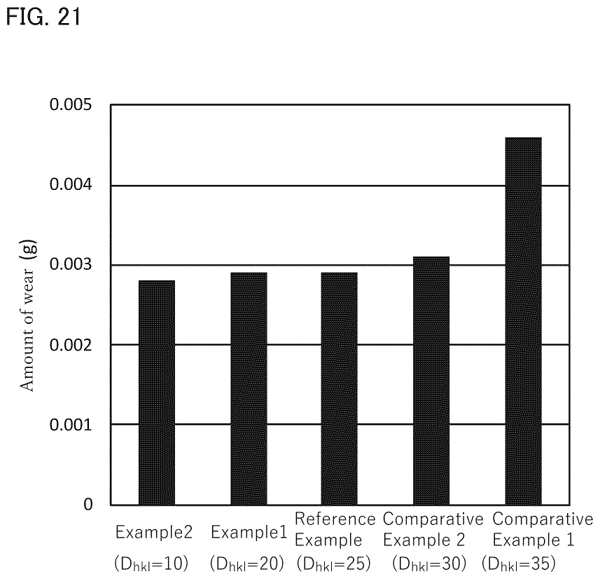

FIG. 20 is a graph illustrating the amount of grinding of the workpiece after the comparative test in which the workpiece was polished using each of the abrasive stick 10 of Example 2, the abrasive stick 10 of Reference Example, and the abrasive stick 10 of Comparative Example. FIG. 20 also illustrates the amount of grinding by the abrasive stick 10 of Example 1 and the amount of grinding by the abrasive stick 10 of Comparative Example 1 in FIG. 12. FIG. 21 is a graph illustrating the amount of wear of the abrasive stick 10 after the comparative test in which the workpiece was polished using each of the abrasive stick 10 of Example 2, the abrasive stick 10 of Reference Example, and the abrasive stick 10 of Comparative Example. FIG. 21 also illustrates the amount of wear of the abrasive stick 10 of Example 1 and the amount of wear of the abrasive stick 10 of Comparative Example 1 in FIG. 13.

As can be understood from the graph illustrating the amount of grinding of the workpiece after the comparative test in FIG. 20, all of the abrasive stick 10 of Example 1 (Dₕₖₗ=20 (nm)), the abrasive stick 10 of Example 2 (Dₕₖₗ=10 (nm)), and the abrasive stick 10 of Reference Example (Dₕₖₗ=25 (nm)) have grinding power equivalent to the abrasive stick 10 of Comparative Example 1 (Dₕₖₗ=35 (nm)) and the abrasive stick 10 of Comparative Example 2 (Dₕₖₗ=30 (nm)). Specifically, the amount of grinding by the abrasive stick 10 of Example 1 is 0.110 g. The amount of grinding by the abrasive stick 10 of Example 2 is 0.109 g. The amount of grinding by the abrasive stick 10 of Reference Example is 0.111 g. The amount of grinding by the abrasive stick 10 of Comparative Example 2 is 0.111 g. The amount of grinding by the abrasive stick 10 of Comparative Example 2 is 0.111 g.

As can be understood from the graph illustrating the amount of wear of the abrasive stick 10 after the comparative test in FIG. 21, the amount of wear of the abrasive stick 10 of Example 1 (Dₕₖₗ=20 (nm)), the amount of wear of the abrasive stick 10 of Example 2 (Dₕₖₗ=10 (nm)), and the amount of wear of the abrasive stick 10 of Reference Example (Dₕₖₗ=25 (nm)) are smaller than the amount of wear of the abrasive stick 10 of Comparative Example 1 (Dₕₖₗ=35 (nm)) and the amount of wear of the abrasive stick 10 of Comparative Example 2 (Dₕₖₗ=30 (nm)). Specifically, the amount of wear of the abrasive stick 10 of Example 1 is 0.0029 g. The amount of wear of the abrasive stick 10 of Example 2 is 0.0028 g. The amount of wear of the abrasive stick 10 of Reference Example is 0.0029 g. The amount of wear of the abrasive stick 10 of Comparative Example 1 is 0.0046 g. The amount of wear of the abrasive stick 10 of Comparative Example 2 is 0.0031. Here, the amount of wear of the abrasive sticks 10 of Example 1, Example 2, and Reference Example is smaller than 0.003 g, which is smaller than the amount of wear of the abrasive stick of Comparative Example 1 by more than 35%.

The experiment by the inventors has proven that the smaller the average grain size of mullite crystals in the crystal structure of the inorganic filaments 15 of the abrasive stick 10, the smaller the amount of wear of the abrasive stick 10. In other words, when the grain size of the mullite crystals is smaller than 10 nm and the precise grain size is unable to be obtained because the peak of the diffraction line of the (210) plane of mullite is buried in other diffraction lines, the amount of wear of the abrasive stick 10 is smaller than the amount of wear of the abrasive stick 10 of Example 2. Thus, the smaller the average grain size of the mullite crystals in the crystal structure of the inorganic filaments 15, the higher the wear resistance of the abrasive stick 10.

The surface roughness of the surface S to be polished of the workpiece W calculated based on the roughness curve (FIG. 17) of the surface to be polished of the workpiece polished with the abrasive stick 10 of Example 2 (Dhkl=10 (nm)) is Rz 2.04 μm. The surface roughness of the surface S to be polished of the workpiece W calculated based on the roughness curve (FIG. 18) of the surface to be polished of the workpiece polished with the abrasive stick 10 of Reference Example (Dhkl=25 (nm)) is Rz 2.06 μm. The surface roughness of the surface S to be polished of the workpiece W calculated based on the roughness curve (FIG. 10) of the surface to be polished of the workpiece polished with the abrasive stick 10 of Example 1 (Dhkl=20 (nm)) is Rz 2.05 μm. This value is between the value of surface roughness when the workpiece is polished with the abrasive stick 10 of Example 2 and the value of surface roughness when the workpiece is polished with the abrasive stick 10 of Reference Example.

The surface roughness of the surface S to be polished of the workpiece W calculated based on the roughness curve (FIG. 17) of the surface to be polished of the workpiece polished with the abrasive stick 10 of Comparative Example 2 (Dhkl=30 (nm)) is Rz 2.17 μm. Furthermore, the surface roughness of the surface S to be polished of the workpiece W calculated based on the roughness curve (FIG. 11) of the surface to be polished of the workpiece polished with the abrasive stick 10 of Comparative Example 1 (Dhkl=35 (nm)) is Rz 4.13 μm. Thus, the smaller the average grain size of crystal grains of mullite crystals of the inorganic filaments 15, the smaller the surface roughness of the surface S to be polished of the workpiece W as the occurrence of scratches and the like is suppressed.

### Operation Effects

As supported by the above comparative test, even when the mullite crystals have an average grain size smaller than 25 nm in the crystal structure of the inorganic filaments 15, the abrasive stick 10 can achieve grinding power equivalent to when the mullite crystals have an average grain size of 25 nm or more.

With the smaller average grain size of the mullite crystals in the crystal structure of the inorganic filaments 15 of the abrasive stick 10, the occurrence of scratches and the like is suppressed, and the surface roughness of the surface S to be polished of the workpiece W after polishing is reduced. Thus, the abrasive stick 10 with the mullite crystals having an average grain size smaller than 25 nm in the crystal structure of the inorganic filaments 15 can reduce the surface roughness of the surface S to be polished of the workpiece W after polishing, compared with when the mullite crystals have an average grain size of 25 nm or more.

Furthermore, in the abrasive stick 10 with the mullite crystals having an average grain size smaller than 25 nm in the crystal structure of the inorganic filaments 15, the wear resistance of the abrasive stick 10 is improved, compared with when the mullite crystals have an average grain size of 25 nm or more.

When the mullite crystals have an average grain size of 20 nm or less in the crystal structure of the inorganic filaments 15, the surface roughness of the surface S to be polished of the workpiece W after polishing can be reduced, compared with when the mullite crystals have an average grain size exceeding 20 nm. When the mullite crystals have an average grain size of 20 nm or less in the crystal structure of the inorganic filaments 15, the wear resistance of the abrasive stick 10 is further improved, compared with when the mullite crystals have an average grain size exceeding 20 nm.

1. An abrasive stick in a rod shape having a distal end portion pressed against a surface to be polished of a workpiece to polish the surface to be polished, the abrasive stick comprising:
a plurality of inorganic filaments extending in an axial direction; and a resin impregnating the inorganic filaments and solidified, wherein
cross sections of the inorganic filaments are exposed on a distal end surface of the abrasive stick,
the abrasive stick has elasticity to flex in a direction intersecting the axial direction,
the inorganic filaments comprise 80 to 90% by weight of an alumina component and 20 to 10% by weight of a silica component,
the inorganic filaments have a crystal structure including mullite crystals and intermediate alumina,
the mullite crystals have an average grain size smaller than 25 nm,
a peak of a diffraction line of a (110) plane of mullite appears in a diffraction chart obtained by irradiating the inorganic filaments with X-rays, and
the average grain size of the mullite crystals is calculated by the following formula based on the diffraction chart:
$$\\ \begin{matrix}{D}_{hkl} = \frac{0.9 λ}{{β}_{\frac{1}{2}} \cdot cos θ} & [ Math . 1 ]\end{matrix}$$
Dₕₖₗ: an average grain size of a (210) plane
λ: a wavelength of X-rays
θ: a glancing angle of X-rays
β_{1/2}: a full width at half maximum of a diffraction line of the (210) plane of mullite in which a crystal structure 2θ by X-ray diffraction appears near 26°.

2. The abrasive stick according to claim 1, wherein the mullite crystals have an average grain size of 20 nm or less.

3. The abrasive stick according to claim 1, wherein the inorganic filaments comprise 85% by weight or more of an alumina component.

4. The abrasive stick according to claim 1, wherein the resin is epoxy resin.

5. The abrasive stick according to claim 1, wherein the abrasive stick has a bending strength of 500 MPa or more and a bending elasticity of 50 GPa or more.

6. A polishing method comprising:
attaching the abrasive stick according to claim 1 to a vibratory tool; and
vibrating a distal end portion of the abrasive stick in the axial direction while pressing the distal end portion against a surface to be polished of a workpiece.

7. A polishing method comprising:
attaching the abrasive stick according to claim 1 to a vibratory tool; and
vibrating a distal end portion of the abrasive stick in the axial direction and in a direction intersecting an axis of the abrasive stick while pressing the distal end portion against a surface to be polished of a workpiece.

8. A polishing method comprising:
attaching the abrasive stick according to claim 1 to a rotary tool; and
rotating a distal end portion of the abrasive stick pressed against a surface to be polished of a workpiece, wherein
the abrasive stick has a circular cross section.
